(19) United States
(12) Patent Application Publication
(10) Pub. No.: US 2024/0043328 A1
(43) Pub. Date: Feb. 8, 2024

(54) Reusable Freely-Shapable Eco-friendly Recycled Brick Manufacturing Process and Product

(71) Applicants: Jhong-He CHEN, Taichung City (TW); Bo-Heng CHEN, Taichung City (TW); Li-Ying CHEN, Taichung City (TW)

(72) Inventors: Jhong-He CHEN, Taichung City (TW); Bo-Heng CHEN, Taichung City (TW); Li-Ying CHEN, Taichung City (TW)

(21) Appl. No.: 18/362,840

(22) Filed: Jul. 31, 2023

(30) Foreign Application Priority Data
Aug. 3, 2022 (TW) 111129219

(51) Int. Cl. C04B 18/167; C04B 20/02

(52) U.S. Cl. CPC C04B 18/167; C04B 20/026; C04B 2111/00017

(57) ABSTRACT

Disclosed are a reusable freely-shapable eco-friendly recycled brick manufacturing process and its product. The manufacturing process includes the steps of: (S1): preparing a raw material of a calcium silicate board; (S2): preparing a raw material of a gypsum board, mixing it with the raw material of the calcium silicate board obtained in (S1) and crushing them into fine powder; (S3): preparing a raw cement and mix it with the fine powder obtained in (S2); (S4): preparing raw water and mix it with the mixture obtained in (S3); (S5): preparing an enhancer and mix it with the mixture obtained in (S4), wherein the enhancer includes little surfactant and adhesive; (S): uniformly mix the raw materials prepared according to the eco-friendly recycled brick manufacturing process and their proportion, and pouring them into at least one mold; and (S7): forming the eco-friendly recycled brick product.

### BACKGROUND OF THE INVENTION

### 1. Field of the Invention

The present disclosure relates to a manufacturing process and a product made by the manufacturing process, and more particularly to a reusable freely-shapable eco-friendly recycled brick manufacturing process and a product made by the manufacturing process.

### 2. Description of Related Art

A conventional red brick is mainly made by mixing sand and clay, and then putting the mixture to be fired into a kiln. Since the mixture of sand and clay contains miscellaneous substances and stones, it is necessary to manually pick out the miscellaneous substances and stones when making bricks. If the water content of the mixture exceeds about 10% and the mixture is put into the kiln and fired at a high temperature of about 500 degrees Celsius, the brick will break easily during firing. Therefore, the mixture of sand and clay must be set aside for ventilation for several days, thus taking much time and incurring a higher cost. In addition, the conventional red brick has the following drawbacks: (1) The weight of is heavier, so that the floor carries heavier loads; (2) The red brick is more absorbent; (3) The red brick is easier to produce wall mold; (4) The red brick manufacturing process mainly relies on heating, and the brick will expand and deform after heating, thus resulting in a failure of meeting required specifications; (5) The surface of the red brick is rough and uneven; (6) The hollow red brick has low density and poor sound insulation; (7) The red brick cannot be reused, greatly reducing practicality. The aforementioned drawbacks are what the people skilled in art and consumers are eager to overcome and break through.

### SUMMARY OF THE INVENTION

In view of the aforementioned drawbacks of the related art, it is a primary objective of the present disclosure to overcome the drawbacks of the related art by providing a reusable freely-shapable eco-friendly recycled brick manufacturing process and its product, which prepare raw materials of a calcium silicate board and a gypsum board, mix and crush them into a fine powder, and mix the fine powder with cement, water, and other chemicals in a specific proportion, and further mix them uniformly before pouring the mixture into a mold, and finally form the eco-friendly recycled brick product.

A secondary objective of this disclosure is to provide a reusable freely-shapable eco-friendly recycled brick manufacturing process and its product, and the eco-friendly recycled brick includes a recycled brick body having a face, a hole formed on the face, a fixing hole formed adjacent to the hole and having a fixing rod that serves as an insert part to be inserted into the hole, and the face is provided with lines. The raw materials of the eco-friendly recycled brick include but not limited to a calcium silicate board and a gypsum board crushed into a fine powder, cement, water and an enhancer containing a surfactant and an adhesive, and the surfactant includes but not limited to a plant based surfactant.

Another objective of this disclosure is to provide a reusable freely-shapable eco-friendly recycled brick manufacturing process and its product, and the manufactured eco-friendly recycled brick has the features of consistent specification, uneasy deformation, smooth and fine surface, lightweight, good shock resistance, good water resistance, and good sound insulation.

A further objective of this disclosure is to provide a reusable freely-shapable eco-friendly recycled brick manufacturing process and its product, and the manufactured brick has the effects of effectively enhancing the convenience of its use, manufacturing the freely-shaped bricks easily, achieving the reuse purpose, and conforming to environmental protection and green energy requirements.

The problems that this disclosure intends to overcome are as follows. The conventional red brick is mainly made by mixing sand and clay, and putting the mixture to be fired into a kiln. Since the mixture contains miscellaneous substances and stones, it is necessary to manually pick out the miscellaneous substances and stones when making bricks. If the water content of the mixture exceeds about 10% when it is entered into the kiln and fired at a high temperature, the brick will break easily during firing. Therefore, the mixture of sand and clay must be set aside for ventilation for several days, thus taking much time and incurring a higher cost. Furthermore, the traditional red brick has the following drawbacks: (1) The weight of is heavier, so that the floor carries heavier loads; (2) The red brick is more absorbent; (3) The red brick is easier to produce wall mold; (4) The red brick manufacturing process mainly relies on heating, and the brick will expand and deform after heating, thus resulting in a failure of meeting required specifications; (5) The surface of the red brick is rough and uneven; (6) The hollow red brick has low density and poor sound insulation; (7) The red brick cannot be reused, thus reducing practicality greatly.

To achieve the aforementioned and other objectives, this disclosure provides a reusable freely-shapable eco-friendly recycled brick manufacturing process that includes the following steps:
(S1): Prepare a raw material of a calcium silicate board;
(S2): Prepare a raw material of a gypsum board, mix it with the raw material of the calcium silicate board obtained in the step (S1), and crush the mixture of the two raw materials into a fine powder;
(S3): Prepare a raw material of cement, and mix it with the fine powder obtained in the step (S2);
(S4): Prepare raw water, and mix it with the mixture obtained in the step (S3);
(S5): Prepare an enhancer, and mix it with the mixture obtained in the step (S4), wherein the enhancer contains a small amount of a surfactant and an adhesive;
(S6): Uniformly mix the raw materials prepared according to the steps of the aforementioned eco-friendly recycled brick manufacturing process and their specific proportion, and then pour them into at least one mold;
(S7): Form an eco-friendly recycled brick product.

Wherein, the proportion of the crushed fine powder of the calcium silicate board and the gypsum board, the cement, and the enhancer is 1:1:1.

Wherein, the proportion of the adhesive in the enhancer is 0.1%-0.2% of the surfactant.

To achieve the aforementioned and other objectives, this disclosure provides a product produced in accordance with a reusable freely-shapable eco-friendly recycled brick manufacturing process of this disclosure, and the eco-friendly recycled brick includes: at least one recycled brick body having at least more than three faces, and the recycled brick body being in a geometric three-dimensional shape or any three-dimensional shape, and the raw materials of the eco-friendly recycled brick including but not limited to a calcium silicate board and a gypsum board which are crushed into a fine powder, cement, water and an enhancer containing a surfactant and an adhesive, and the surfactant including but not limited to a plant based surfactant.

Wherein, the recycled brick body simultaneously includes at least two holes, or at least one of the faces includes at least two holes.

Wherein, the recycled brick body includes at least two fixing holes formed adjacent to the hole, and the inner sidewall of the fixing hole is threaded or flat, and the fixing hole penetrates through the recycled brick body or does not penetrate through the recycled brick body, and an end surface of the fixing hole of the recycled brick body is a plane, a convex surface or a concave surface, and the fixing hole is provided with a fixing rod that serves as an insert part.

Wherein, the fixing rod includes but not limited to an expansion screw, a screw rod or a stud corresponding to the fixing hole with the threaded or flat inner sidewall.

Wherein, the hole of the recycled brick body is provided for inserting at least one insert part; the insert part is an insert part of a pipe, including but not limited to a hollow pipe or a solid pipe.

Wherein, the recycled brick body has a plurality of lines or patterns formed on one or more of the faces, and each line is a regular line or an irregular line in the shape of a concave line or a convex line.

Compared with the effects of the related art, this disclosure uses a process to prepare the raw materials of the calcium silicate board and the gypsum board, mix and crush them into a fine powder, and further mix the fine powder with the cement, water and enhancer according to a specific proportion, and then mix them uniformly before pouring the mixture into a mold, and finally forming an eco-friendly recycled brick product. The eco-friendly recycled brick includes: the recycled brick body with the face, and the face is provided with a the hole, and the fixing hole formed adjacent to the hole and having the fixing rod that serves as an insert part, and the insert part is inserted into the hole, and the face is provided with the lines. The eco-friendly recycled brick raw material includes but not limited to the calcium silicate board and the gypsum board which are crushed into a fine powder, the cement, the water and the enhancer containing the surfactant and the adhesive, wherein the surfactant includes but not limited to a plant based surfactant, Therefore, the eco-friendly recycled brick so manufactured has the features of consistent specification, uneasy deformation, flat and fine surface, and light weight, as well as the vibration-resisting, water-resisting, and sound insulating effects. This disclosure effectively improves the convenience of its use and freely-shaping and manufacturing and also achieves the reusable, eco-friendly and green energy effects, which greatly expands the industrial utilization of the industry and complies with the patent application requirements for novelty and inventiveness.

### BRIEF DESCRIPTION OF THE DRAWINGS

FIG. 1 is a flow chart of an eco-friendly recycled brick manufacturing process of this disclosure;

FIG. 2 is a raw material structure diagram of an eco-friendly recycled brick of this disclosure;

FIG. 3 is a perspective view of an eco-friendly recycled brick of this disclosure;

FIG. 4 is a structure diagram of an eco-friendly recycled brick with a fixing rod in accordance with this disclosure; and

FIG. 5 is a structure diagram of an eco-friendly recycled brick with a pattern in accordance with this disclosure.

### DETAILED DESCRIPTION OF THE PREFERRED EMBODIMENT

This disclosure will now be described in more detail with reference to the accompanying drawings that show various embodiments of this disclosure. It is intended that the embodiments and drawings disclosed herein are to be considered illustrative rather than restrictive, and also noteworthy that the drawings are not necessary drawn according to the real proportion and precise configuration and these attached drawings should not limit the scope of the patent of this disclosure in actual implementation.

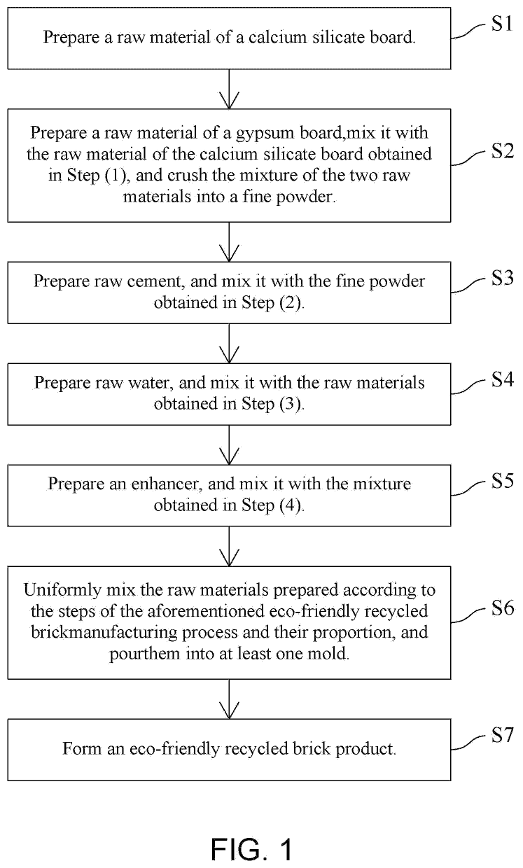

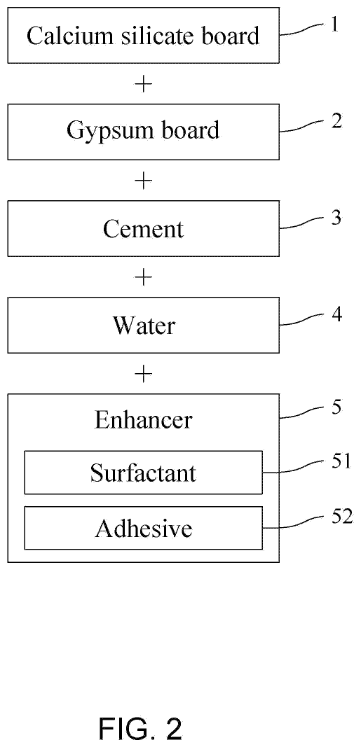

With reference to FIGS. 1 to 5 for a flow chart of a reusable freely-shapable eco-friendly recycled brick manufacturing process, a raw material structure diagram and a perspective view of an eco-friendly recycled brick, a structure diagram of the eco-friendly recycled brick with a fixing rod, and a structure diagram of the eco-friendly recycled brick with a pattern in accordance with this disclosure respectively, the reusable freely-shapable eco-friendly recycled brick manufacturing process, includes the following steps (S1)˜(S7) (see FIGS. 1 and 2):
(S1): Prepare a raw material of a calcium silicate board 1.
(S2): Prepare a raw material of a gypsum board 2, mix it with the raw material of the calcium silicate board 1 obtain in the step (S1), and crush the mixture into a fine powder. In this embodiment, no specific proportion of the calcium silicate board 1 and the gypsum board 2 is required, and the calcium silicate board 1 and the gypsum board 2 are mainly used to be mixed and crushed into the fine powder. The proportion of the calcium silicate board 1 and the gypsum board 2 which are crushed into a fine powder, the cement 3 and the enhancer 5 is 1:1:1. The crushed fine powder of the raw materials of the calcium silicate board 1 and the gypsum board 2 obtained in the step (S2) is prepared by a device including but not limited to a crusher.
(S3): Prepare a raw material of cement 3, and mix it with the fine powder of the crushed raw materials of the gypsum board 2 and the calcium silicate board 1 obtained in the step (S2).
(S4): Prepare raw water 4, and mix it with the mixture obtained in the step (S3).
(S5): Prepare an enhancer 5 and mix it with the mixture obtained in the step (S4), wherein the enhancer 5 contains a small amount of a surfactant 51 and an adhesive 52; and the surfactant 51 of the enhancer 5 includes but not limited to a plant based surfactant; the proportion of the adhesive 52 in the enhancer 5 is 0.1%-0.2% of the surfactant 51. In this embodiment, the enhancer 5 is mainly used to enhance the eco-friendly recycled brick again.
(S6): Uniformly mix the raw materials prepared according to the steps of the aforementioned eco-friendly recycled brick manufacturing process and their specific proportion, and pour them into at least one mold.
(S7): Form an eco-friendly recycled brick product.

The differences between the eco-friendly recycled brick of this disclosure and the traditional red brick are as follows.
(1) The conventional red bricks used to build walls or to lay floors absorb water and cause deformation easily, so that the construction process must go through a multiple of processes. For example, the red bricks used to build walls or lay floors having a rough surface need to be covered with coarse sand cement, and then put on with fine sand cement to make the surface smooth before and then soil is applied the before coloring or other subsequent constructions. On the other hand, the surface of the eco-friendly recycled brick of this disclosure is smooth and fine, so that the bricks can be laid directly.
(2) The eco-friendly recycled brick of this disclosure reduces the time-consuming, labor-intensive, and material-intensive processes of the traditional construction, greatly saves related building materials and construction costs, and shortens the construction time.
(3) The eco-friendly recycled brick of this disclosure is less likely to absorb water and deform when used outdoors, especially when it is laid as floor tiles.

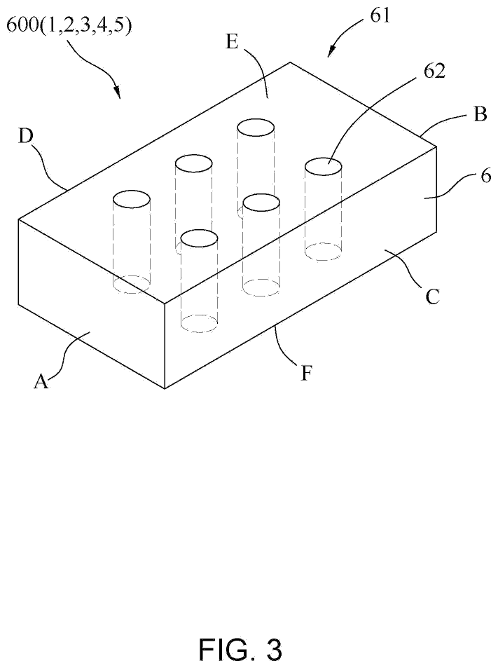

This disclosure discloses a reusable freely-shapable eco-friendly recycled brick manufacturing process and its product, and the eco-friendly recycled brick 600 manufactured according to the eco-friendly recycled brick manufacturing process of this disclosure includes: at least one recycled brick body 6, having at least more than three faces 61; the recycled brick body 6 is in a geometric three-dimensional shape or any three-dimensional shape, including but not limited to the shape of a tetrahedron, a square, a cuboid, or a cylinder; the raw material of the eco-friendly recycled brick 600 includes but not limited to a calcium silicate board 1 and a gypsum board 2 which are crushed into a fine powder, cement 3, water 4 and an enhancer 5 containing a surfactant 51 and an adhesive 52, and the surfactant 51 includes but not limited to a plant based surfactant (as shown in FIG. 2. In this embodiment, the recycled brick body 6 is in the shape of a cuboid with six faces 61 including a front face A, a rear face B, a left face C, a right face D, a top face E and a bottom face F. All faces of the recycled brick body 6 simultaneously have at least two holes 62 or at least one of the faces 61 has at least two holes 62, so as to enhance the vibration resisting and sound insulating effects of the building built by the recycled brick body 6 (as shown in FIG. 3).

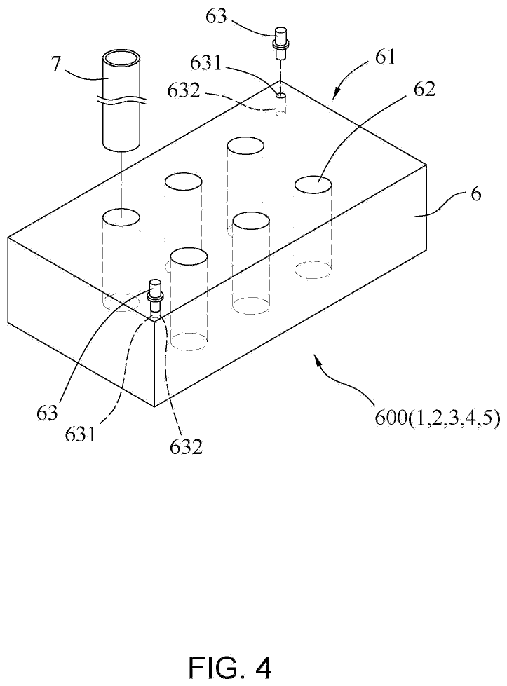

In FIGS. 4 and 2, the recycled brick body 6 of this disclosure has at least two fixing holes 631 formed adjacent to the hole 62, and the fixing hole 631 has an inner sidewall 632 which is threaded or flat, and the fixing hole 631 of the recycled brick body 6 penetrates through the recycled brick body 6 or does not penetrate through the recycled brick body 6. The fixing hole 631 of the recycled brick body 6 has an end surface, which can be a plane, a convex surface or a concave surface; and each of the fixing holes 631 of the recycled brick body 6 is provided with a fixing rod 63 that serves as an insert part, so that the recycled brick body 6 of this disclosure can be used for construction more accurately during the process of laying walls or floors. By inserting the fixing rod 63 of the recycled brick body 6 of one eco-friendly recycled brick 600 into the fixing hole 631 of the other eco-friendly recycled brick 600, bad bricklaying of walls or floors can be avoided. The fixing rod 63 includes but not limited to an expansion screw, a screw rod or a stud corresponding to the threaded or flat fixing hole 631 of the inner sidewall 632. The raw material of the eco-friendly recycled brick 600 includes but not limited to the calcium silicate board 1 and the gypsum board 2 which are crushed into a fine powder, the cement 3, the water 4 and the enhancer 5 containing the surfactant 51 and the adhesive 52 (as shown in FIG. 2). The hole 62 can be formed during the process or after the recycled brick body 6; is made, and the hole 62 of the recycled brick body 6 is provided and inserted with at least one insert part 7 to further enhance the vibration resistance of the building of this disclosure, as well as enhancing the sound insulating effect. The insert part 7 of the hole 62 is an insert part of a pipe including but not limited to a hollow pipe or a solid pipe (as shown in FIG. 4).

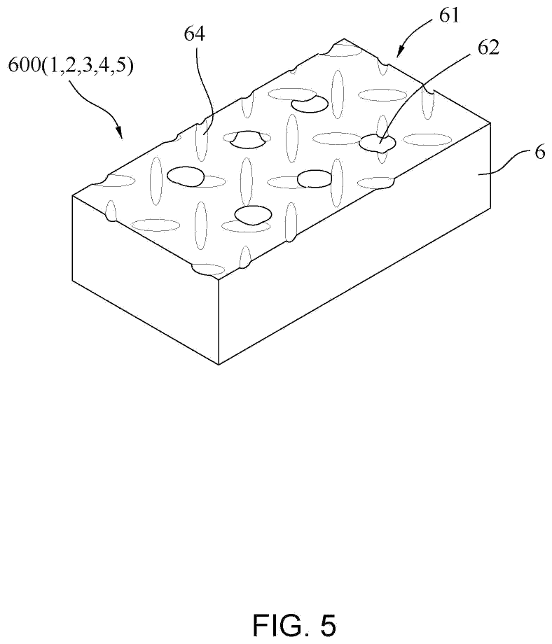

In FIG. 5, the recycled brick body 6 of this disclosure has a plurality of lines 64 or patterns 65 (not shown in the figure) formed on one or more of the faces 61 (as shown in FIG. 5), and the lines 64 are regular lines or irregular lines; and the line 64 is in the shape of a concave line or a convex line for a multi-functional purpose including anti-slip, increase of friction, good fixation and alignment between eco-friendly recycled bricks 600, and avoidance of bad bricklaying.

The aforementioned product of the eco-friendly recycled brick 600 has the following features (compared to traditional red bricks):
(1) Consistent specification.
(2) Uneasy deformation.
(3) Smooth and fine surface.
(4) Lightweight (i.e. the floor carries a lesser load).
(5) Good vibration resistance.
(6) Good water resistance.
(7) Good sound insulating effect.
(8) After the eco-friendly recycled brick 600 of this disclosure is used in a building, eco-friendly recycled brick 600 can be dismantled and reused by repeating the aforementioned process, so as to reduce the consumption of various building materials such as sand, water, etc. and manpower, and greatly improve the utilization of the building materials.
(9) The eco-friendly recycled brick conforms to environment protection and green energy requirements.

The process of this disclosure is used to prepare the raw materials of the calcium silicate board 1 and the gypsum board 2 which are crushed into a fine powder, the cement 3, the water 4 and the enhancer 5 according to a specific proportion, and mix the mixture uniformly before pouring the mixture into a mold, and finally form the product of the eco-friendly recycled brick 600. The eco-friendly recycled brick 600 includes the recycled brick body 6 having the face 61, and the face 61 is provided with the hole 62, and the fixing hole 631 is formed adjacent to the hole 62 and provided with the fixing rod 63 that serves as an insert part. The hole 62 is inserted with the insert part 7, and the face 61 is provided with the lines 64. The raw materials of the eco-friendly recycled brick 600 include but not limited to the calcium silicate board 1 and the gypsum board 2 which are mixed and crushed into a fine powder, the cement 3, the water 4 and the enhancer 5 containing the surfactant 51 and the adhesive 52, and the surfactant 51 includes but not limited to a plant based surfactant. In summation, the eco-friendly recycled brick 600 of this disclosure has the features of consistent specification, uneasy deformation, smooth and fine surface, lightweight, good vibration resistance, good water resistance, and good sound insulating effect. The reusable freely-shapable eco-friendly recycled brick of this disclosure has the effects of effectively enhancing the convenience of its use, manufacturing the freely-shaped bricks easily, achieving the reuse purpose, and conforming to environmental protection and green energy requirements.

What is claimed is:

1. A reusable freely-shapable eco-friendly recycled brick manufacturing process, comprising the steps of:
(S1): preparing a raw material of a calcium silicate board;
(S2): preparing a raw material of a gypsum board, mixing the raw material of the gypsum board with the raw material of the calcium silicate board obtained in the step (S1), and crushing the mixture of the two raw materials into a fine powder;
(S3): preparing raw cement and mixing the raw cement with the fine powder obtained in the step (S2);
(S4): preparing raw water and mixing the raw water with the mixture obtained in the step (S3);
(S5): preparing an enhancer, and mixing the enhancer with the mixture obtained in the step (S4), wherein the enhancer contains a small amount of a surfactant and an adhesive;
(S6): Uniformly mix the raw materials prepared according to the eco-friendly recycled brick manufacturing process and a specific proportion of the raw materials, and pour the mixture of the raw materials into at least one mold; and
(S7): forming an eco-friendly recycled brick product.

2. The reusable freely-shapable eco-friendly recycled brick manufacturing process according to claim 1, wherein the proportion of the crushed fine powder of the calcium silicate board and the gypsum board, the cement, and the enhancer is 1:1:1.

3. The reusable freely-shapable eco-friendly recycled brick manufacturing process according to claim 1, wherein the proportion of the adhesive in the enhancer is 0.1%-0.2% of the surfactant.

4. A reusable freely-shapable eco-friendly recycled brick product manufactured by the manufacturing process according to any one of claims 1 to 3 comprising at least one recycled brick body, having at least more than three faces, and the recycled brick body being in a geometric three-dimensional shape or any three-dimensional shape, and the eco-friendly recycled brick raw material includes but not limited to a calcium silicate board and a gypsum board which are crushed into a fine powder, cement, water and an enhancer comprising a surfactant and an adhesive, and the surfactant including but not limited to a plant based surfactant.

5. The reusable freely-shapable eco-friendly recycled brick product according to claim 4, wherein the recycled brick body simultaneously comprising at least two holes, or at least one of the faces comprising at least two holes.

6. The reusable freely-shapable eco-friendly recycled brick product according to claim 5, wherein the recycled brick body comprises at least two fixing holes formed adjacent to the hole, and the inner sidewall of the fixing hole is threaded or flat, and the fixing hole penetrates through the recycled brick body or does not penetrate through the recycled brick body, and an end surface of the fixing hole of the recycled brick body is a plane, a convex surface or a concave surface, and the fixing hole is provided with a fixing rod that serves as an insert part.

7. The reusable freely-shapable eco-friendly recycled brick product according to claim 6, wherein the fixing rod includes but not limited to an expansion screw, a screw rod or a stud corresponding to the fixing hole with the threaded or flat inner sidewall.

8. The reusable freely-shapable eco-friendly recycled brick product according to claim 5 or 6, wherein the hole of the recycled brick body is provided for inserting at least one insert part, which is an insert part of a pipe, including but not limited to a hollow pipe or a solid pipe.

9. The reusable freely-shapable eco-friendly recycled brick product according to claim 4, 5 or 6, wherein the recycled brick body has a plurality of lines or patterns formed on one or more of the faces, and each line is a regular lines or an irregular line in the shape of a concave line or a convex line.
